(19) United States
(12) Patent Application Publication
(10) Pub. No.: US 2009/0219800 A1
(43) Pub. Date: Sep. 3, 2009

(54) Transmission Method with Optimal Power Allocation Emitted for Multicarrier Transmitter

(76) Inventor: Wladimir Bocquet, Tokyo (JP)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/280,632

(22) PCT Filed: Feb. 23, 2007
(86) PCT No.: PCT/FR07/50845

§ 371 Date: Mar. 24, 2009

(30) Foreign Application Priority Data
Feb. 23, 2007 (FR) 0650629

(51) Int. Cl. H04L 27/26; H04J 11/00

(52) U.S. Cl. 370/208; 375/260; 375/296; 370/210

(57) ABSTRACT

A transmission method (1) for an N carrier transmitter (EM). The principle of the method is to select a set of carriers from the N carriers and distribute them amongst subgroups in application of a determined criterion and to determine a set of powers transmitted per subgroup that complies with an optimum frequency distribution of the total power transmitted by said set among the subcarriers of the set, by minimizing an overall error criterion (BER) under the constraint that the sum of the powers of a set is equal to the product of the number N_{tg} of carriers of the subgroup multiplied by the total mean power transmitted over the N carriers.

The present invention relates in general to so-called digital communications that form part of the field of telecommunications. Digital communications comprises in particular wireless communications in which the transmission channel is an air channel, and also communications by wire. Within this field, the invention relates to transmission methods and more particularly to multiple carrier transmission techniques. These techniques comprise, in particular, techniques of the orthogonal frequency division multiplexed (OFDM) type or of the orthogonal frequency division multiplexed access (OFDMA) type.

An essential characteristic of OFDM transmission techniques is to reduce the data rate of each subcarrier while providing transmission at a high bit rate by using the subcarriers simultaneously. The frequency band is subdivided into small ranges, each allocated to a respective different subcarrier. The subcarriers are mutually orthogonal. This property is obtained by spacing the subcarriers apart by a multiple of the reciprocal of the symbol duration. A multicarrier modulation system can provide immunity against selective frequency fading occurring during transmission over the channel as a result of not all of the subcarriers being subjected to the fading simultaneously. Nevertheless, in order to combat this fading phenomenon, the transmission channel needs to be estimated and corrected for each subcarrier on reception of the transmitted signal.

An OFDM transmitter performs various treatments on the incoming high bit rate binary data in order to generate a so-called OFDM signal that is transmitted over the channel. Thus, the high bit rate binary data is encoded, e.g. using a convolution code, and it is modulated, e.g. by binary phase-shift keying (BPSK), quadrature phase-shift keying (QPSK), or 16 quadrature amplitude modulation (16QAM). The data is then converted into parallel form as a plurality of data streams each modulated at a low rate for feeding subcarrier branches of an OFDM multiplexer. The multiplexer performs frequency division multiplexing by means of an N-point inverse discrete Fourier transform (IDFT). The resulting OFDM signal is converted into analog form by a digital-to-analog converter and is shifted by a frequency converter (U/C) (up converted (U/C)) towards a radiofrequency (RF) band for transmission into the transmission channel.

Typically, an OFDM system conveys N symbols during the i^{th} OFDM symbol period on N subchannels determined by subcarriers that are spaced apart by 1/N. For the i^{th} block, the baseband OFDM signal as transmitted is expressed in the form:

$${x}_{k}^{( i )} = \frac{1}{\sqrt{N}} \cdot {\sum }_{n = 0}^{N - 1} {s}_{k}^{( i )} \cdot exp \{ j \frac{2 π nk}{N} \} 0 \leq k < N \qquad ( 1 )$$

in which expression N is the size of a block and \vec{s}⁽ⁱ⁾ is the i^{th} transmitted symbol sequence.

In order to combat intersymbol interference (ISI), and intercarrier interference (ICI), a guard interval (GI) such as a cyclic prefix (CP) or zero padding (ZP) is added to each OFDM symbol. This guard interval makes it possible to avoid any overlap between OFDM symbols when the transmission delay is less than the duration of the interval. When the guard interval is an extension of the output sequence, i.e. when its content is a copy of a portion of the output signal, then the transmitted signal is expressed in the following form:

$${\tilde{x}}_{k}^{( i )} = \{ \begin{matrix}{x}_{N - G + k}^{( i )} & 0 \leq k < G \\ {x}_{k - G}^{( i )} & G \leq k < N + G\end{matrix} \qquad ( 2 )$$

in which expression G is the length of the guard interval.

Assuming that the transmission channel is made up of P discrete paths each characterized by a respective amplitude and delay, then the baseband impulse response of the channel can be expressed in the following form:

$$h ( t , τ ) = {\sum }_{p = 0}^{P - 1} {α}_{p} ( t ) \cdot δ ( τ - {τ}_{p} ) \qquad ( 3 )$$

with αₚ and τₚ respectively constituting the complex gain of the channel and the delay of the p^{th} path, known as the spreading delay. The total power transmitted by the channel over the various subcarriers is normalized to 1.

Another assumption consists in considering that τₘₐₓ=max τⱼ<Tg=the duration of the guard interval.

The transfer function H(t,f) of the channel can be expressed in the frequency domain in the following form:

$$H ( t , f ) = {\sum }_{p = 0}^{P - 1} {α}_{p} ( t ) \cdot exp [ - j 2 π f {τ}_{p} ] \qquad ( 4 )$$

On reception by a receiver, the received signal is filtered by a bandpass filter (BPF) and is shifted into baseband (down converted (D/C)). The signal is sampled by an analog-to-digital converter (A/D). After eliminating the guard interval, the sampled data is fed to a N-point discrete Fourier transform (DFT) and is demultiplexed into as many branches as there are subcarriers.

If the guard interval is longer than the maximum spreading delay, then the received signal as shifted into baseband can be expressed in the following form:

$${r}_{k}^{( i )} = {\sum }_{p = 0}^{P - 1} {α}_{p} \cdot {x}_{k - {τ}_{p}}^{( i )} + {\tilde{n}}_{k}^{( i )} 0 \leq k < N \qquad ( 5 )$$

with \vec{r}⁽ⁱ⁾=[r₀⁽ⁱ⁾ . . . r_{N-1}⁽ⁱ⁾] and ñ⁽ⁱ⁾=[ñ₀^{(l)} . . . ñ_{N-1}^{(l)}] respectively designating the received signal and the additional Gaussian white noise for the i^{th} OFDM symbol after the guard interval has been eliminated and prior to processing.

To reduce the distortion effects of the channel, it is known to compensate the channel in the frequency domain subcarrier by subcarrier, making use of coefficients that are determined in particular as a function of a minimum mean square error (MMSE) criterion or a zero-forcing (ZF) equalization criterion.

Thereafter, in each branch, the data is demodulated and decoded. This compensation amounts to multiplying the received signal by the reciprocal of the channel gain for any given subcarrier. This method has the drawback of increasing the noise level on reception, in particular when the value of the channel gain is small, a situation that is typically to be found in the event of fading.

Thus, the invention proposes a transmission method performing space-division multiplexing of a signal for transmission over N carriers, the signal being transmitted with a determined power Pᵤ per carrier, thereby combating fading phenomena without increasing the noise level in the received signal.

The proposed method is a transmission method for a system having at least one transmission antenna and at least one reception antenna separated by a transmission channel, which system performs space-division multiplexing of a signal for transmission over a plurality of carriers. The signal is transmitted over the various carriers at a respective power that is determined for each carrier. The method distributes a set of carriers from among the N carriers into subgroups in application of a determined criterion. The method determines a set of powers to be transmitted by each carrier subgroup. Each set of determined powers complies with an optimum frequency distribution of the total transmitted power for the set among the carriers of the set. This set is determined by minimizing an overall error criterion (BER, PER) under the constraint that the sum of the determined powers of a set is equal to the product of the number of carriers of the subgroup multiplied by the total mean power transmitted over all of the carriers.

By searching for a set of transmitted powers that enables an overall error criterion to be minimized per carrier subgroup, typically an overall bit error rate (BER), a method of the invention takes account of propagation conditions in order to adjust the power transmitted on the various carriers, and consequently enables an optimized frequency distribution of the transmitted power to be obtained that serves to combat the fading phenomena better and thus to improve the efficiency of the system.

The overall error criterion is typically a bit error rate (BER), but it could equally well be a packet error rate (PER), which is an error measurement criterion that is commonly used in systems implementing channel encoding relying for example on a convolution code, a turbocode, or an LDPC code. In so-called coded systems, it is possible to make use of both overall error criteria, both BER and PER.

Propagation channel variations between adjacent subcarriers generally take place slowly. Consequently, in the event of a large amount of fading, the variations associated with the channel give rise to a large amount of disturbance in the adjacent subcarriers.

Thus, in a particular implementation, the subcarriers that are the most strongly affected by a channel disturbance such as fading are grouped together with the subcarriers that are affected the least. A method of evaluating the impact of fading in the frequency domain consists in calculating the powers of the channel coefficients, commonly written |Hₘ|², where m is the carrier index. Under such circumstances, the criterion for distributing carriers among subgroups is the power level of the channel coefficients.

Other characteristics and advantages of the invention appear from the following description with reference to the accompanying figures given as non-limiting examples.

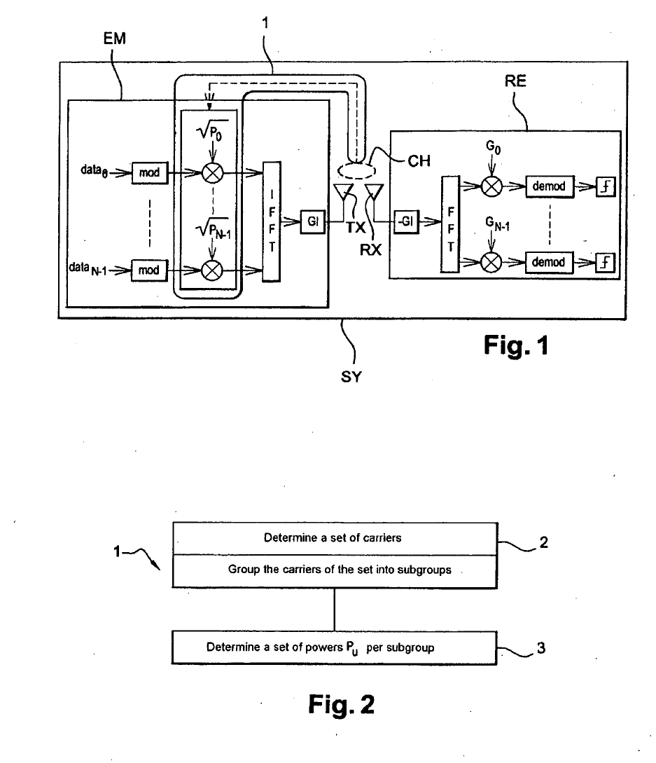

FIG. 1 is a block diagram of a transmission system including air transmission implementing a method of the invention.

FIG. 2 is a flow chart of a method of the invention.

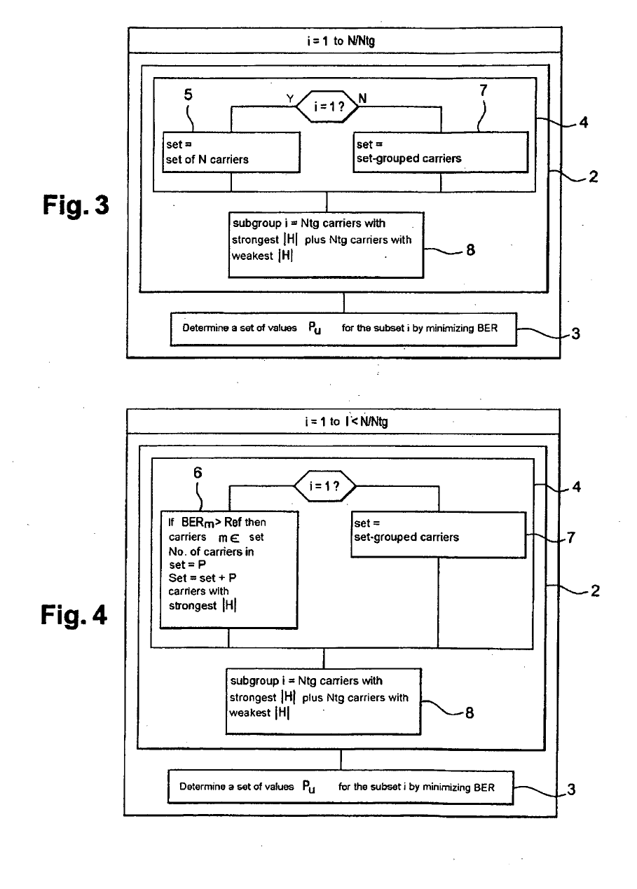

FIG. 3 is a flow chart of a first implementation of a method of the invention.

FIG. 4 is a flow chart of a second implementation of a method of the invention.

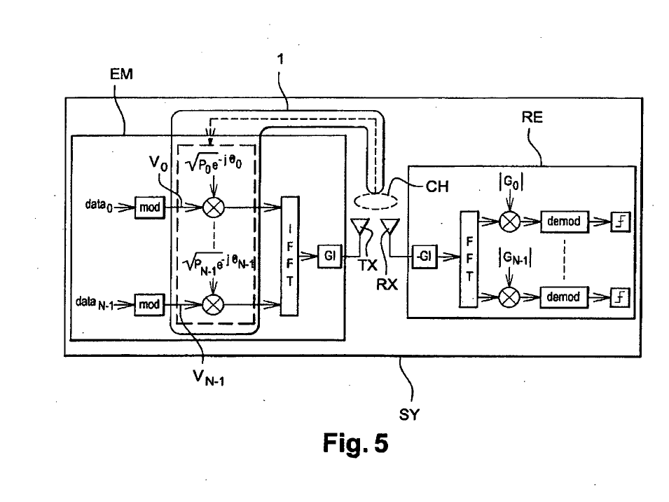

FIG. 5 is a block diagram of a transmission system with air transmission implementing a particular implementation of the method of the invention.

FIG. 1 is a diagram showing an example of a transmission system SY implementing a method of the invention. The system comprises a transmitter EM (for emitter), transmission antennas TX, reception antennas RX, and a receiver RE. The transmission and reception antennas are separated by a transmission channel CH.

The method 1 of the invention is represented diagrammatically by a return loop and per subcarrier weighting coefficients for the signal as transmitted. The method optimizes the distribution of power transmitted per subcarrier on the basis of knowledge about the transmission conditions of the channel. The return loop makes it possible to take account of channel state information (CSI) in the expression for the overall error criterion. The return loop is an illustration of making use of pilot symbols that enable the characteristics of the channel to be determined in application of techniques that are known to the person skilled in the art, and in particular to determine the transfer function of the channel. Depending on the mode of transmission, e.g. of the frequency or time division duplex (FDD or TDD) type, knowledge at the transmitter of Hₘ requires or does not require information to return from the receiver to the transmitter.

Thus, this makes it possible for the modulus and the phase of each of the channel coefficients to be known:

Hₘ=|Hₘ|e^{jφ} (6)

FIG. 2 is a flow chart of a method of the invention.

The method 1 is a method of transmission that multiplexes a signal for transmission on N carriers by space division. The signal is transmitted with a determined power Pᵤ per carrier.

In a first step 2, the method subdivides a set of carriers taken from the N carriers into subgroups in application of a determined criterion.

The criterion is typically a power level of the coefficients |Hₘ|² of the transmission channel.

In a second step 3, following or interleaved with the preceding step, the method determines a set of powers to be transmitted per subgroup.

The method is described in greater detail with reference to FIGS. 3 and 4 which are respective detailed flow charts for first and second implementations of a method of the invention.

In these implementations, the first and second steps 2 and 3 are reiterated a certain number of times.

The first step 2 comprises a first substep and a second substep.

In a first substep 4, the method determines a set of carriers.

In the first implementation, for the first iteration, this set is made up (5) of the N subcarriers.

In the second implementation, for the first iteration, this set is made up (6) of a subset of the set of N carriers. This subset comprises the subcarriers that are the most disturbed by the channel and those that are the least disturbed, in equal numbers. The most disturbed subcarriers are selected by retaining those subcarriers for which the value obtained for the error criterion is greater than a reference value.

The description below of this second implementation is given with reference to the particular example in which the overall error criterion is the binary error rate (BER). Under such circumstances, the implementation relies on the assumption that the binary error rate associated with a subcarrier m, BERₘ, can be estimated by the following equation:

BERₘ≈a·exp(−b·βₘ·pₘ/(M−1)) (7)

in which:

$${β}_{m} = \frac{1}{{σ}_{n}^{2} \cdot {\vert {G}_{m} \vert}^{2}} \qquad ( 8 )$$

and in which M=2^{Nm}, is the number of modulation words, given that Nm is the number of bits per symbol, Gₘ is the channel compensation value due to selected frequency fading on the frequency m, a=0.1 is a first heuristic coefficient, and b=3.0 is a second heuristic coefficient. With zero-forcing equalization, the relationship between Hₘ and Gₘ is given by:

$${G}_{m} = \frac{{H}_{m}^{*}}{{\vert {H}_{m} \vert}^{2}}$$

where * means the conjugate value;

and when using minimum mean square error (MMSE) equalization, the relationship between Hₘ and Gₘ becomes equal to:

$${G}_{m} = \frac{{H}_{m}^{*}}{{\vert {H}_{m} \vert}^{2} + {σ}_{n}^{2}}$$

where σₙ² represents the variance of the noise.

Thus, to compare the binary error rate obtained for a subcarrier with a reference value, it suffices to compare the value of βₘ obtained for said subcarrier with a threshold value β that corresponds to a BER reference value, using the approximation that pₘ is the power transmitted on subcarrier m. By way of example, the reference BER is equal to 10⁻⁴. Thus, to determine the subset, the method compares a threshold value with the values for βₘ that are associated with the various subcarriers. The method selects those subcarriers for which βₘ is greater than the threshold value, i.e. those subcarriers that lead to a binary error rate that is greater than the reference rate. This selection is accompanied by an identical number of subcarriers presenting the best values for βₘ, and thus the lowest binary error rates. This second implementation has the advantage of being less complex than the first implementation, since the powers transmitted are determined only for some of the subcarriers.

In both implementations, during the following iterations, the set of carriers is reduced (7) to those subcarriers that are grouped together during the preceding iteration.

In a second subset 8, during iteration i, the method groups together in an i^{th} subgroup of size N_{tg}, the N_{tg}/2 subcarriers for which the channel gain is the strongest with the N_{tg}/2 subcarriers for which the channel gain is the weakest.

The number of iterations in the process is typically equal to N/N_{tg} in the first implementation. This first implementation assumes that the following constraint is satisfied: N modulo N_{tg}=0, which amounts to saying that N/N_{tg}=k where k is a natural integer. In the second implementation, the number I of iterations is less than N/N_{tg}.

In the second step 3, following or interleaved with the preceding step, the method determines a set of powers transmitted per subgroup. The set of determined powers complies with an optimum frequency distribution amongst the subcarriers of the set, for the total power that is transmitted for said set. This optimum distribution is obtained by minimizing an overall error criterion, under the constraint that the sum of the powers of the set of a subgroup is equal to the product of the number N_{tg} of carriers in the subgroup multiplied by the mean total power P̅ transmitted on the N subcarriers. This constraint is expressed in the following form:

$${\sum }_{m = 0}^{{N}_{tg} - 1} {p}_{m} = {N}_{tg} \cdot \overline{P} \qquad ( 9 )$$

In which expression, N_{tg} and pₘ are respectively the size of the subgroup for which minimization is performed and the power allocated to subcarrier m of the subgroup.

The overall error criterion is typically the binary error rate BER. The binary error rate BER is a function of the signal-to-noise ratio SNR. In a channel with flat fading, this rate can be expressed as a function of the power pₘ transmitted per subcarrier m and a coefficient βₘ:

BER=f(βₘ,pₘ) (10)

where βₘ is determined by equation (8).

The binary error rate, BER, is minimized when it is minimized for each frequency subband corresponding to a subcarrier. To determine the minimum value, one solution consists in using a Lagrangian algorithm.

Minimization can be expressed as follows:

$$min f ( {β}_{m} , {p}_{m} ) with {\sum }_{m = 0}^{{N}_{tg} - 1} {p}_{m} = {N}_{tg} \cdot \overline{P} \qquad ( 11 )$$

Equation (11) represents the fact that the method minimizes the BER by determining the best set of transmitted powers under the constraint that the total power transmitted over all of the N_{tg} subcarriers must be constant and fixed.

Equations (11) can be solved by implementing a Lagrangian algorithm. For each subgroup of subcarriers, the Lagrangian can be expressed in the form:

$$J ( {p}_{0} , … , {p}_{{N}_{tg} - 1} ) = \frac{1}{{N}_{tg}} {\sum }_{m = 0}^{{N}_{tg} - 1} f ( {β}_{m} {p}_{m} ) + λ ( \begin{matrix}{\sum }_{m = 0}^{{N}_{tg} - 1} {p}_{m} - \\ {N}_{tg} \cdot \overline{P}\end{matrix} ) \qquad ( 12 )$$

In order to obtain an optimum set of transmitted powers, the method solves the system of equations:

$$\{ \begin{matrix} \frac{1}{{N}_{tg}} \cdot \frac{\partial }{\partial {p}_{m}} ( {\sum }_{m = 0}^{{N}_{tg} - 1} f ( {β}_{m} , {p}_{m} ) ) + λ = 0 m = 0 , … , {N}_{tg} - 1 \\ {\sum }_{m = 0}^{{N}_{tg} - 1} {p}_{m} - {N}_{tg} \cdot \overline{P} = 0\end{matrix} \qquad ( 13 )$$

By introducing the simplified estimate for the BER given by equation (7), the system (13) can be expressed in the following form:

$$\{ \begin{matrix} \frac{- a \cdot b \cdot {β}_{m}}{M - 1} \cdot exp ( - b \cdot \frac{{β}_{m} , {p}_{m}}{M - 1} ) + λ = 0 m = 0 , … , {N}_{tg} - 1 \\ {\sum }_{m = 0}^{{N}_{tg} - 1} {p}_{m} - {N}_{tg} \cdot \overline{P} = 0\end{matrix} \qquad ( 14 )$$

This leads to the following expression for the determined transmitted power for a subcarrier:

$${p}_{u} = {[ 1 + {\sum }_{{m = 0}_{M \neq l}}^{{N}_{tg} - 1} \frac{{β}_{u}}{{β}_{m}} ]}^{- 1} \cdot ( {N}_{tg} \cdot \overline{P} + \frac{1}{b} \cdot {\sum }_{{m = 0}_{M \neq l}}^{{N}_{tg} - 1} \frac{1}{{β}_{m}} \cdot ln ( \frac{{β}_{u}}{{β}_{m}} ) ) \qquad ( 15 )$$

The method takes account of an additional constraint when implementing a Lagrangian algorithm leads to a solution that does not represent physical reality, typically when the power obtained is negative. Under such circumstances, the method can eliminate the subcarrier from the set of subcarriers.

In the first implementation described, the method determines a transmitted power for each subcarrier of each subgroup by minimizing an overall error criterion.

FIG. 5 is a block diagram of a transmission system using air transmission and implementing a particular implementation of the method of the invention. Elements in FIG. 5 that are identical to elements in FIG. 1 are given the same reference numerals and they are not described again.

In this particular implementation, the transmission method (1) acts on transmission to compensate the phase shift φ introduced by the channel. Thus, for each subcarrier m, the signal Vₘ to be transmitted is phase-shifted by a value −φ and is weighted by the square root of the determined transmitted power value. This can be expressed by the following equation:

Vₘ·\sqrt{pₘ}·e^{-jφ} (16)

A method of the invention can be implemented using various means. For example, the method can be implemented in hardware form, in software, or in a combination of both.

For a hardware implementation, the module for determining a power set that is used for performing the various steps in the transmitter can be integrated in one or more application specific integrated circuits (ASICs), in one or more digital signal processors (DPS, DSPDs), in programmable logic circuits (PLDs, FPGAs), in controllers, microcontrollers, microprocessors, or any other electronic component designed to execute the above-described functions.

In a software implementation, some or all of the steps of a transmission method of the invention can be implemented by software modules executing the functions described above. The software code can be stored in a memory and executed by a processor. The memory may form part of the processor, or it may be external to the processor and coupled thereto by means known to the person skilled in the art.

Consequently, the invention also provides a computer program, in particular a computer program on or in a data medium or a memory, and suitable for implementing the invention. The program can make use of any programming language, and it can be in the form of source code, object code, or of code that is intermediate between source code and object code, such as in a partially compiled form, or in any other form that is desirable for implementing a method of the invention.

The data medium may be any entity or device capable of storing the program. For example, the medium may comprise storage means such as a read-only memory (ROM), e.g. a CD-ROM, or a microelectronic circuit ROM, or indeed magnetic recording means, e.g. a floppy disk or a hard disk.

Furthermore, the data medium may be a transmissible medium such as an electrical or optical signal, suitable for being conveyed by electric or optical cable, by radio, or by other means. The program of the invention may in particular be downloaded from an Internet type network.

Consequently, the invention also provides a digital signal for use in a transmitter performing space-division multiplexing of a signal that is to be transmitted over N subcarriers, the signal being transmitted with a determined power Pᵤ per subcarrier. The digital signal includes at least code for enabling the transmitter to execute the following steps:
distributing a set of subcarriers taken from the N subcarriers amongst subgroups in application of a determined criterion; and
determining a set of powers transmitted per subgroup that satisfy an optimum frequency distribution of the total power transmitted by the set amongst the subcarriers of the set, by minimizing an overall error criterion under the constraint that the sum of the powers of a set is equal to the product of the number N_{tg} of subcarriers of the subgroup multiplied by the total mean power transmitted over the N subcarriers.

1. A transmission method (1) comprising the steps of:
frequency-division multiplexing a signal for transmission over N subcarriers,
distributing (2) a set of subcarriers taken from the N subcarriers into subgroups depending on power levels of coefficients of a transmission channel; and
determining (3) a set of transmitted powers per subgroup,
wherein the signal is transmitted with a determined power Pᵤ per subcarrier and wherein the set of powers transmitted per subgroup complies with an optimum frequency distribution of the total power transmitted by the set among the subcarriers of the set, by minimizing an overall error criterion per subcarrier under the constraint that the sum of the powers of a set is equal to the product of the number N_{tg} of subcarriers of the subgroup multiplied by the mean total power transmitted over the N subcarriers.

2. The transmission method (1) according to claim 1, wherein the signal to be transmitted over N subcarriers is transmitted by a transmitter (EM), and is transmitted over a transmission channel (CH) between the transmitter and a receiver (RE) of the transmitted signal, and wherein the signal (V₀, . . . , V_{N-1}) for transmission is phase-shifted by a phase value that is the inverse of the phase shift introduced by the transmission channel.

3. The transmission method (1) according to claim 1, wherein the set of subcarriers is constituted (6) in part by subcarriers selected as a function of a reference value for the overall error criterion.

4. The transmission method (1) according to claim 1, wherein the overall error criterion is minimized by means of a Lagrangian algorithm.

5. The transmission method (1) according to claim 1, wherein the overall error criterion corresponds to a bit error rate, BER.

6. The transmission method (1) according to claim 1, wherein the bit error rate is estimated by an exponential function in order to obtain an analytic expression for the determined power Pᵤ per subcarrier.

7. The transmission method (1) according to claim 1, wherein the overall error criterion corresponds to an overall packet error rate, PER.

8. A transmitter (EM) performing frequency-division multiplexing of a signal for transmission over N subcarriers and including a module for distributing a set of subcarriers taken from the N subcarriers among subgroups depending on power levels of coefficients of a transmission channel, wherein for the signal being transmitted with a determined power Pᵤ per subcarrier, the transmitter comprises a module for determining a set of powers transmitted per subgroup that complies with an optimum frequency distribution of the total transmitted power for the set among the subcarriers of the set, by minimizing an overall error criterion per subcarrier under the constraint that the sum of the powers of a set is equal to the product of the number N_{tg} of subcarriers of the subgroup multiplied by the total mean power transmitted over the N subcarriers.

9. A transmission system (Sy) including a transmitter (EM) according to the claim 1.

10. A computer program stored on a data medium, said program including program instructions adapted to implementing a transmission method according to claim 1, when said program is loaded and executed in a transmitter.

11. A data medium including program instructions adapted to implementing a transmission method according to claim 1 when said program is loaded and executed in a transmitter.
